(19) United States
(12) Patent Application Publication
(10) Pub. No.: US 2017/0032426 A1
(43) Pub. Date: Feb. 2, 2017

(54) AUTHENTICATED WORD OF MOUTH MESSAGING PLATFORM

(71) Applicant: WEBFLUTTER MEDIA . CORPORATION, Lebanon, NJ (US)

(72) Inventor: MaryJane Salvato, Lebanon, NJ (US)

(21) Appl. No.: 15/223,517

(22) Filed: Jul. 29, 2016

Related U.S. Application Data
(60) Provisional application No. 62/198,349, filed on Jul. 29, 2015.

(51) Int. Cl. G06Q 30/02; H04L 12/58; H04L 29/08

(52) U.S. Cl. CPC G06Q 30/0269; H04L 67/18; H04L 51/32; G06Q 50/01

(57) ABSTRACT

A computer based method is provided wherein a platform first records a first message relating to a product or service at a first interface device and publishes that message to a social media platform only after authenticating that a first user accessing the first interface device has had access to the product or service. The platform then records, at a second interface device, a second message responsive to the first message from a secondary user, and publishes the second message to the social media platform only after authenticating that the secondary user has had access to the product or service.

### CROSS REFERENCE TO RELATED APPLICATIONS

This application claims the benefit of U.S. Provisional Patent Application No. 62/198,349, filed Jul. 29, 2015, the contents of which are incorporated by reference herein in their entirety.

### FIELD OF THE INVENTION

The invention relates to systems and methods for capturing consumer Word of Mouth (WOM) reviews in a message format, such as a personalized video or a still image about a product or service, and distributing the WOM reviews on social media platforms, as well as valuing the WOM reviews and making them available as advertisements.

### BACKGROUND

The growing numbers of internet media platform technologies are dividing the consumer viewing audiences and challenging marketers to effectively engage consumers with their marketing messages. Traditional impersonal advertising on internet platforms are ignored by consumers and Key Performance Indicators (KPI) show low returns on digital marketing efforts across interne and social media platforms. At the same time, the consumers themselves have become an active voice in the marketing message on social media platforms. Consumer reviews of products and services, as well as social commentary from consumers increasingly influence consumer's purchasing decisions. As the number of sources of information grows and advertising becomes ubiquitous, consumers are more likely to ignore traditional advertising and turn to their friends and family for recommendations. Accordingly, WOM advertising is not only the most trusted source of consumer information, it is the source of information most likely to be acted upon, according to a Nielsen article in 2013. See Under the Influence: Consumer Trust In Advertising, posted on Sep. 7, 2013, available at http://www.nielsen.com/us/en/insights/news/2013/under-the-influence-consumer-trust-in-advertising.html, last visited Jul. 26, 2016).

Further, it is known to be less expensive to cater to existing customers and maintain their business satisfaction than to find new customers. Referrals and recommendations from existing customers are therefore valuable to operating a successful business. They demonstrate a good experience and that a level of trust has been achieved with consumers. Referrals which are delivered through word of mouth between consumers are an efficient way to organically gain new customers, rather than actively finding them, and lower the acquisition cost of those new customers. Often, business owners do not know if they are achieving a level of service high enough to earn a referral or recommendation, nor do have the ability to track when a customer makes such a referral, or when it leads to a sale.

Further, while messages may be generated through paid testimonials by hiring spokesman to create “personal” messages, such messages may be viewed with apprehension as to the motivations of the sender for creating the message. Further, viewers of such messages may not be certain whether the originator of the message ever actually encountered the product or service being reviewed.

Finally, consumers viewing such messages on a social media platform may see messages repeated or commented on by third parties who “like,” or “retweet” the message, and consumers may not know if the user's repeating such messages ever encountered the product or service being reviewed.

Accordingly, there is a need for a platform that provides a Customer Relationship Management (CRM) tool to effectively bridge the existing gap between social media platform interaction and brand messaging while increasing the integrity of the messaging itself. There is further a need for such a platform that can support and properly incentivize direct consumer to consumer marketing through messaging.

### SUMMARY

The systems and methods embodied in the platform described below provide a structure for unstructured WOM data and assists consumer who participate in the platform in preparing messages and publishing those messages to one or more social media platforms. Further, the platform creates an environment in which the consumers participating in the platform may earn compensation from helping others find positive consumer experiences from personal feedback. The methods described create a framework in which consumers can earn compensation without being directly hired to create paid testimonials, since such paid testimonials may lead to apprehension about the motivations of the sender's message. Instead, the sender's initial message is evaluated by the receiver as valuable and is passed along as a confirmation based on personal taste. The veracity of the message therefore provides a chain of common taste within dense data of the social graph.

Typically, a first user may record a first message relating to a product or service that they recently encountered at a first interface device, such as the user's smartphone, and publish that message to a social media platform. In some embodiments, the first user's message may only publish after confirming that the first user has had access to the product or service.

A secondary user viewing the first message may then record, at their own smartphone, a second message responsive to the first message. The platform may then publish the second message to the social media platform only after confirming that the secondary user has had access to the product or service that the first message relates to.

The second message may be a simple comment on the first message, such as an indication that they agree or disagree with the contents of the first message. Alternatively, or in addition to the indication, the secondary user may create a more comprehensive message. In some embodiments, the secondary user is prompted to create a more comprehensive message only if the second message indicates agreement with or approval of the first message.

A product or service provider may participate in creating or shaping the messages created by consumers. For example, the brand or business providing the product or service may provide message backgrounds, including animated backgrounds, and make them available as a starting point for the first message. A consumer may then upload a photo, selfie, or video, a picture of a product, and a short audio segment to create a complete message. For instance a business may purchase or create a message background to use as part of the messaging. The message background may include contact information or a hyperlink for the business. The provider may further provide a script or other components to be used in completing an animated message.

Accordingly, in one embodiment, the platform described may utilize a server to store one or more background, including at least one of a static background image, an animated background image and a video image that may include an animation with a hyper link to a website. The messages created using these backgrounds may then be shared over the consumer's social networks or directly on a mobile platform associated with the platform, or other media and communication platforms.

The platform has associated valuation criteria in which a second participant in the platform may view and evaluate the WOM recommendation from the first participant, with respect to his or her personal taste and experience with the brand or business. The platform may confirm that the second participant has had access to the product or service prior to allowing them to evaluate the WOM recommendation based on, for example, location criteria. Accordingly, in some embodiments, the second participant must be a consumer and must be experiencing the product or service on which the first WOM message comments in order to record an evaluation or judgment as to whether the message was useful and agreeable to pass along. This process, occasionally referred to herein as a “came and seen” review process, lends additional value to the WOM messaging and creates value above and beyond current messaging in internet communications, where it is common for users to share, or “like” everything they come across with a click, without verifying that the consumer evaluating the message ever encountered the product or service evaluated. Accordingly, location based authentication criteria may provide a higher level of integrity in the message process and may lend additional value to tracked communications and WOM messages.

In some embodiments, the platform may allow users to leave some level of comment, such as a statement that they like the message, on messages for which they have not encountered the product or service. Occasionally, the recordation of such secondary valuation criteria may be used to evaluate a level of engagement of users with the message. It may also be used to track conversion of message viewers to customers of the product or service. When evaluating the engagement of a message's viewers, a quantity of consumers who viewed and did not encounter the product or service may be considered, and may carry less weight than a quantity of consumers that have encountered the product or service.

As the first message is passed to authenticated secondary users, it gains value, as it is evaluated and rated by those authenticated secondary users as it traverses the social network and is acted upon. Once a value is established, the message may be made available for sale for advertising purposes. For example, the product or service provider may purchase the message to be shown when and where the first user's contacts are online. The advertisements purchased may, for example, feature the first user's face and may therefore command higher recognition and value to secondary user's, thus achieving a higher engagement rate while ultimately providing a higher return on advertising expenditure.

The consumer may share in the proceeds of the message revenue and the earnings through the platform may be deposited in a savings account.

As a CRM tool, the business will be able to leverage the platform to properly engage consumers in a professional yet social setting that focuses on their preferences or tastes. By tracking users on social media, a product or service provider may then discover ones happiest, most engaged, or most popular customers and cater to them with special offers, loyalty rewards or any other combination of promotions, which incentivize the customer to recommend the business and lowers the cost of acquiring customers and raises the value of those who recommend others to the business. Further, the data collected through the platform provides valuable data, such as consumer taste profiles and chains of consumers, all of which may be valuable to target marketing.

### BRIEF DESCRIPTION OF THE DRAWINGS

FIG. 1 illustrates a network that may be used for the platform described.

FIG. 2 illustrates an interface device for use in implementing the platform described.

FIG. 3 illustrates a method for implementing a portion of the platform described.

FIG. 4 illustrates a menu structure for use in a portion of the platform described.

FIG. 5 illustrates the creation of a message in a portion of the platform described.

FIG. 6 illustrates one example of a message background for use in the method of FIG. 3.

FIG. 7 illustrates methods for implementing a portion of the platform described.

FIG. 8 illustrates additional features that may be implemented in the platform described.

FIG. 9 illustrate an authentication method that may be used in the platform described.

FIG. 10 is a schematic diagram illustrating the spread of a message across the platform described.

FIGS. 11A-G are exemplary screenshots of an implementation of the platform described.

FIGS. 12A-D are exemplary screenshots of a further implementation of the platform described.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

Described below are various methods and systems for supporting authenticated word of mouth messaging as a form of marketing for a product or service. The methods and systems may be implemented as a new social media platform, or they may be implemented as part of existing platforms. The tasks performed on the platform may include, for example, the distribution of a first message, or comment, about a product or service across social media platforms where the source of the message is confirmed to have had access to the product or service. The tasks may further include the distribution of secondary messages or comments responsive to, or about, the first message, where the sources of those secondary messages are confirmed to have had access to the product or service as well. The platform may further implement evaluation processes for evaluating the effectiveness and distribution of individual messages as well as sales processes for selling messages as advertisements to be used by product or service providers.

The platform typically implements a Word of Mouth (WOM) based method for distributing messages containing product and service reviews or endorsements. Accordingly, messages recorded within the platform spread organically through connections of users of social networks, and at least some of those messages are authenticated through the method described to confirm that users commenting on or endorsing products or services actually had access to the product or service.

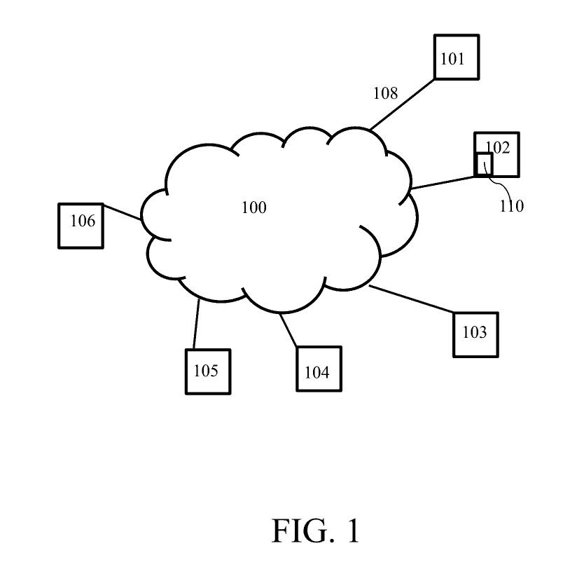

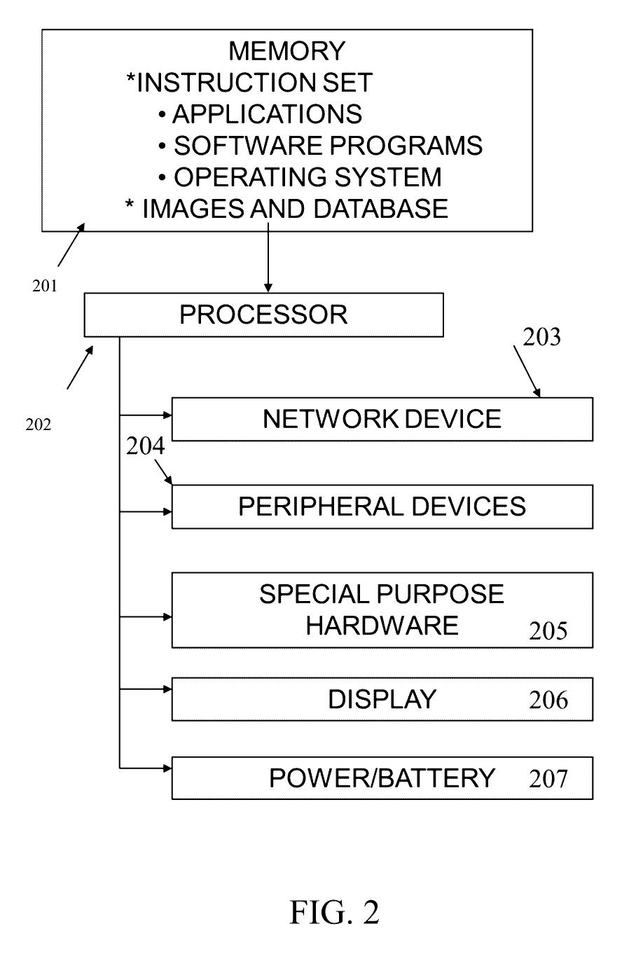

FIG. 1 illustrates a network that may be used to implement the methods and systems described below, and FIG. 2 illustrates a user interface device that may be used to send and receive messages associated with the methods described below.

As shown in FIG. 1, a variety of components are connected to each other through a network 100, such as the internet, in order to implement the platform described. Connected to the network 100 is a plurality of interface devices 101, 102, 103 for use by users of the platform, and which may be mobile or fixed, wireless or wired computing devices. For example, one of the user interface devices 101, 102, 103 may be the device shown in FIG. 2.

Typically, the platform is accessed by a first user at a first interface device 101 at which the first user can create and publish messages created using the methods described below. The platform is then accessed by secondary users at secondary interface devices 102 and 103 who may view and potentially comment on or republish messages, potentially along with indications of approval or disapproval.

Each interface device 101, 102, 103 is connected to the network 100 via a wired or wireless connection 108. Such a connection may be, for example, through WiFi or a cellular or phone network and may be accessed using a transceiver 110 in the device 102.

The platform may further utilize a server 104 that hosts the social media platform and hosts media messages. In some embodiments, certain tasks associated with the social media platform or the messages created at the interface devices 101, 102, 103 may be hosted in separate servers. For example, where a component of the messages to be published is provided by a product or service provider, the provider may maintain a server 105 for hosting its own components of the messages, such as message backgrounds. In some embodiments, such backgrounds may only be available on the premises of the provider. In other embodiments, the provider may make such backgrounds available anywhere via the internet 100 or the provider may distribute the backgrounds to customers. In some embodiments, a third party server 106 may host some backend functions of the platform, such as managing payments to users based on the popularity of their messages or other message monetization schemes.

FIG. 2 illustrates a user interface device, such as device 101, at which a user may create and publish messages via a social media platform. The device has a memory 201 that stores and retrieves data and instructions, such as applications, including the functionality provided herein, an operating system, and data files such as images and other data. The memory in some embodiments stores a database, for instance to hold and retrieve one or more message animation backgrounds, that can be searched by a processor.

The processor 202 retrieves instructions from the memory 201 and executes the instructions. A network device 203 provides interface services between the user interface device 101 and the network 100.

The interface device may further comprise connections for peripheral devices 204, such as input and output devices as well as special purpose hardware 205 for performing specific tasks within the platform. For example, the interface device 101 typically includes a GPS device for implementing geolocation methods, or other hardware, for use in confirming access to a product or service being discussed by the user in the first message. The interface device typically further includes a display 206 as part of a user interface and a power source 207 to lend portability to the device.

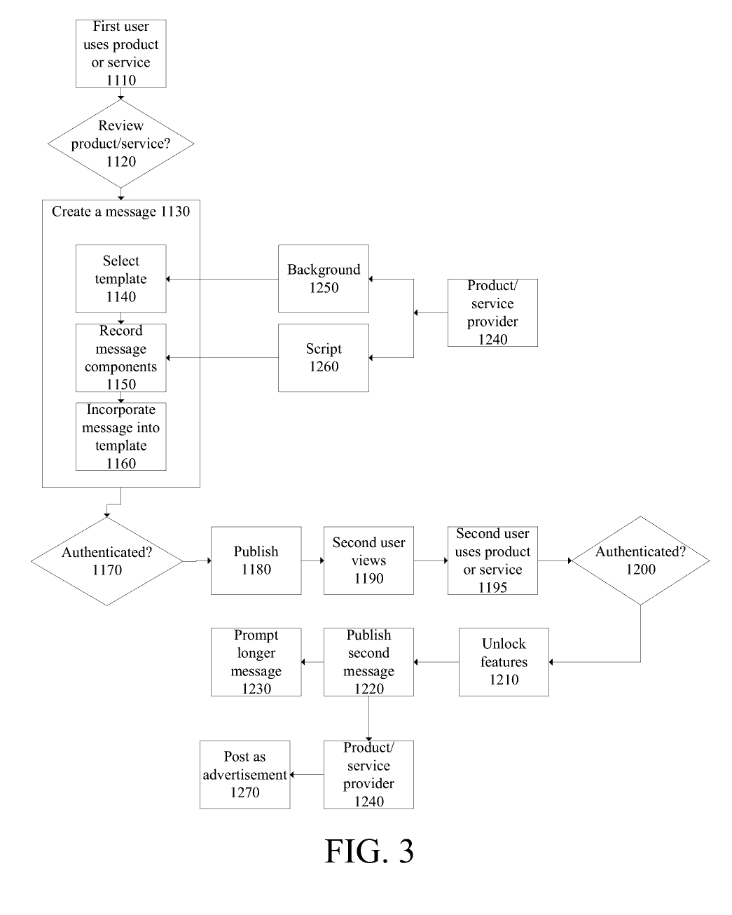

FIG. 3 is a flowchart illustrating a method for distributing authenticated word of mouth messages on a social media platform. As shown, the method begins when a first user uses a product or service (1110) and chooses to broadcast, or publish, a first message relating to the product or service (1120). The first message may be a product review or endorsement or a comment related to a level of service received, for example. The first user may then indicate that they would like to create the message (1130) at a first interface device, such as the device described with respect to FIG. 2, or the user's smartphone.

As shown, the creation of the first message (at 1130) may be based on a template provided to the first user. For example, the platform may provide access to a template that the user can select (1140) and which provides a background for the first message. The user may then record their own personal message components (1150) and incorporate the message components into the template (1160) to create the first message. In some embodiments, a provider of the product or service 1240 may provide the message background (1250) as a template for the first user to select (1140). The message template (selected at 1140) may be a background for an animation that includes information about the product or service provider, such as a name and address, or a hyperlink to the service provider's website.

After the user incorporates his message components into such a template (at 1160), the completed message may be, for example, an animation of an avatar stating the first user's product or service review or a video or audio recording of the user arranged against an animated background provided as part of the template. The avatar may be based on an image or video of the first user recorded as part of the message components recorded. For example, the avatar may incorporate the first user's face. The prepared first message may then be published (1180) to the social media platform.

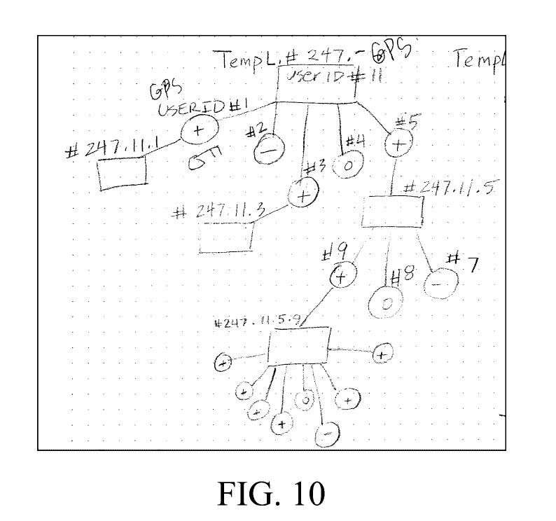

In some embodiments, prior to broadcasting the first message, the platform authenticates that the first user actually had access to the product or service (1170). This may be, for example, by confirming that the first user was at a location at which the service was offered or the product was sold. The confirmation may be by a geolocation process, which may be referred to as a “came and seen” process. Alternatively, the authentication process may be by, for example, reviewing an image of a product being reviewed or a scan of a UPC code from such a product. In some embodiments, a product or service provider may provide the first user with a template directly, or may provide the first user with a link to a website or application for creating the first message. In such embodiments, the possession of such a template, or link, may authenticate the first user. Other methods of authentication are discussed in detail below with respect to FIG. 10.

The publication of the first message (1180) may be on a social media platform uniquely designed to implement the described process, or it may be on a traditional third party social media platform. In some embodiments, the platform described may be a messaging application capable of publishing to a third party social media platform. Accordingly, the publication may be on a social media page specific to the first user, such as the user's Facebook® page or Twitter® feed. While the method is described as authenticating the first message after the creation of the message in implementations where the first message is authenticated, it will be understood that the authentication may occur at any time prior to publication (at 1180).

Once the first message is published to a social media platform, a secondary user, typically a social media connection, such as a “friend” or “follower” of the first user, may view the first message (1190) at a second interface device. The secondary user may then wish to comment on the first message, or otherwise approve or disapprove of the contents of the first message by transmitting their own message. As a condition for publishing such a comment, or recording an expression of approval or disapproval of the contents of a first message, the platform confirms that the second user had access to the product or service that the first message relates to. In some embodiments, the comment is a statement of approval or disapproval of the first message, while in other embodiments, the comment may be a more comprehensive message responsive to the first message.

Accordingly, the secondary user uses the product or service discussed in the first message (1195). The platform then authenticates that the second user had access to the product or service (1200). This authentication may be by utilizing the same types of authentication processes discussed above with respect to the first user (at 1170). After such authentication, options within the platform may unlock (1210), thereby providing an option for the second user to record a second message responsive to the first message. For example, the second user may indicate that they “like” the message on Facebook®, or the second user may “retweet” the message on Twitter® or they may perform a similar action indicating approval or disapproval on a different platform, or record their own message relating to the product or service. Because the platform requires authentication in order to unlock the ability to publish the secondary message (1220), a secondary user using the platform to relay, or republish, the first message is confirmed to have actually had access to the product or service, and their affirmation or disagreement with the first message is therefore more reliable than it might otherwise be. In some embodiments, the first message may accompany the second messages publication.

In some embodiments, a secondary user confirmed to have had access to the product or service may publish their own second message, along with the first message (at 1220) in the form of a “like,” and may then be prompted to leave their own, more substantial message (1230). In some embodiments, the secondary user may only be prompted to leave their own message if the second message provided by the secondary user is positive.

In some embodiments, the initial publication of the first message is a publication to a location within the social media platform associated with the first user, such as the user's Facebook® page or Twitter® feed, and may therefore be accessible to connections of the first user. In such an embodiment, the second message may be published to a location within the social media platform associated with the second user such that it is accessible to connections of the second user.

In some embodiments, the secondary user described herein may be one of many secondary users responding to, or publishing second messages related to, the first message. Each secondary user that is confirmed to have had access to the product or service of the first message may separately create secondary messages responsive to the first message. In such cases, each Secondary user may republish the first message within the social media platform, thereby expanding the reach of the first message.

In some embodiments, a platform implementing the method may record statistics related to the reach and popularity of the first message. For example, the platform may record the number of second messages distributed with respect to any first message, as well as a frequency with which the second messages voice approval of the first message.

In this way, the spread of a message by word of mouth may be tracked. Such tracking is described in more detail below with respect to FIG. 10.

In some embodiments, the platform may incorporate a sales platform, such that the first message may be packaged, with or without the various second messages, as an advertisement for the product or service and may be made available for sale to the provider of the product or service. The price of the advertisement may be based, partially, on the statistics collected by the platform and described above. For example, where a message is republished frequently by secondary users, and where a high percentage of the second messages are by secondary user's that voice approval of the first message, the price to the provider may be higher than where a message is republished less frequently, as it represents more potential revenue and a more positive sentiment captured.

In some embodiments, the provider of the product or service may orchestrate a particular first message in preparation for the purchase of such a message to be used as an ad. In such an embodiment, the provider of the product or service (1240) may create and provide a background (1250) to be used as a template as part of the message creation process (at 1130). The provider may further provide a script (1260) to be used by the first user for the first message.

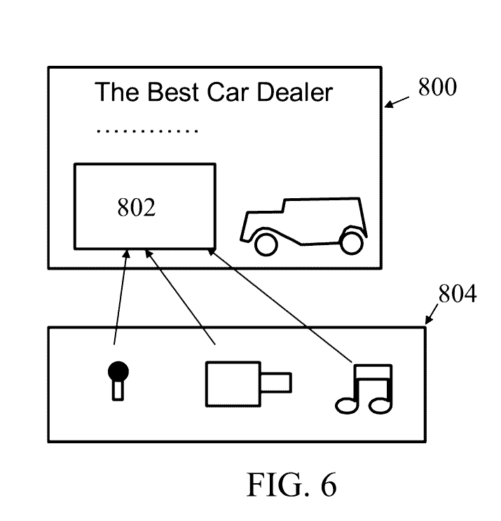

This process is described in more detail below with respect to FIG. 6.

Where a product or service provider (1240) purchases a message to be posted as an advertisement (1270), the message may then be published on social media platforms at locations associated with connections of the first user or the second user. For example, where a secondary user has republished a first message approvingly, the first message may be posted as sponsored content to locations associated with tertiary users connected to the secondary users, along with messages indicating that the second user “liked” the message.

In some embodiments, a secondary user may be alerted that they are eligible to review a product or service once an authentication process occurs, and the user may then be prompted to record and publish a first message or create a second message responsive to the first message. For example, a secondary user may view a first message reviewing a restaurant, and decide to go to that restaurant based on the review. When they are at the restaurant, the secondary user's interface device may alert the user that they are now eligible to record and publish a secondary message and leave a second message related to the first message.

While the method is described with respect to distribution of messages on social media platforms, in some embodiments, the messages may be distributed in different ways as well. For example, the platform may acquire access to a contact database related to the user and location data from their interface device and use that information to distribute the first message. Alternatively, the message may be published on various websites other than social media sites, as well as email and other message platforms.

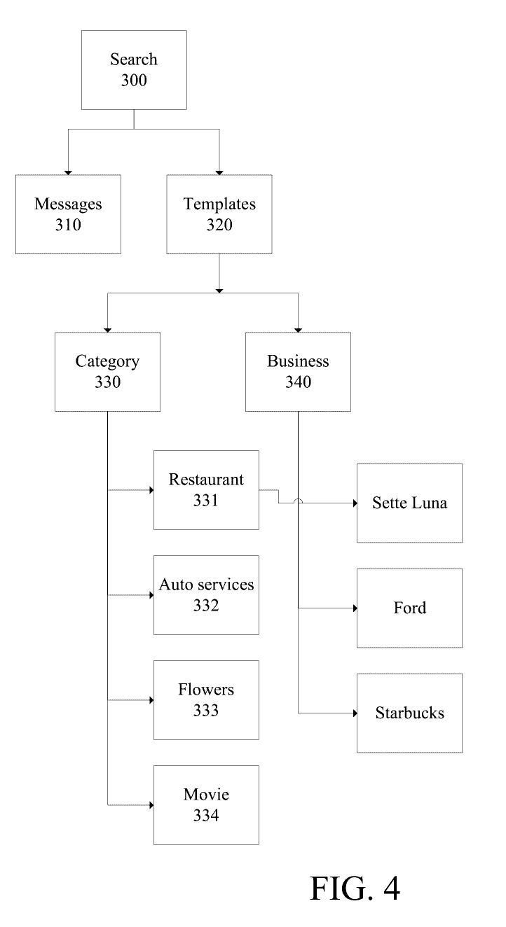

FIG. 4 illustrates a menu structure for use in a portion of the platform described. As shown, a first user can search (300) for a template (320) associated with a product or service that they have recently used. Alternatively, the first user may search for an existing message (310) related to a product or service that they recently used or are considering using.

Where the user chooses to select a template (320), they may be able to search by category (330) or for a specific business (340) that they wish to leave a first message related to. The categories, such as restaurant services (331), auto services (332), flowers (333), or movies (334) may redirect users to services within those categories when selected. Accordingly, a restaurant, such as Sette Luna may be selected by either searching for the particular restaurant, or may be selected by searching for restaurant services (331) more generally. In some embodiments, the businesses (340) presented to a user may be based on geolocation. Alternatively, they may be able to select businesses on a map. Further, the platform may alert users to available templates based on geolocation.

In some embodiments, much of the menu structure may be circumvented by allowing a user to search for a product or service directly. A user may then search for a specific business, such as Ford®, and may be presented with options to either view a first message created by a connection or create their own first message. In some embodiments, the products or services, as well as the messages, presented to the user may be limited based on geographic criteria.

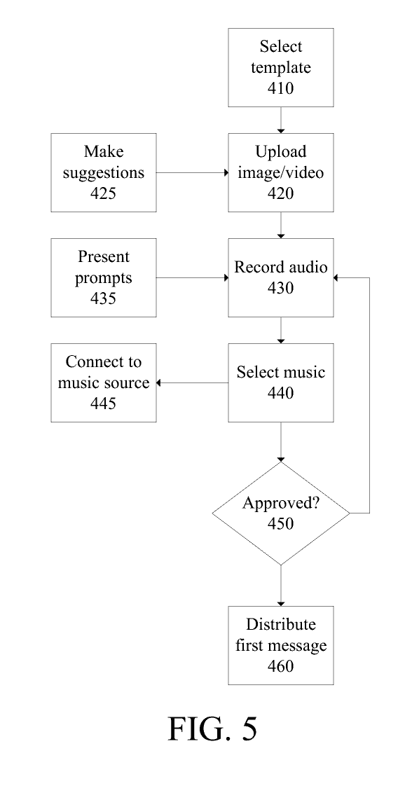

FIG. 5 illustrates the creation of a first message in a portion of the platform described. As shown, a first user may select a template (410) which may be a message background, upload an image or video at their interface device (420), and record audio (430). When the user uploads their image or video, an application may provide suggestions (425) for improving the image or video. For example, the application may indicate shadows in an image, or may incorporate indications in the template for the best angle from which to take a photo or video. In some embodiments, the recorded audio may be from a script provided by the product or service provider (as discussed with respect to 1260). In such an implementation, an application implementing the platform may present prompts to a user for either the entire script or just the recording of taglines for the product (435). The various data is then combined into a digital media message to be used as the first message discussed above.

In some embodiments, the user creating the first message may further personalize the message by selecting music (440) for incorporation into the message. For instance, the user may select music from their own music collection, or the user may select and purchase music for incorporation into the first message through the platform described by connecting directly to a music source (445). In some embodiments, the product or service provider providing the background may incorporate specific music, videos, or images into the template, or may include corresponding suggestions into the script.

In some embodiments, the platform may apply an automated approval process that reviews the message created for inappropriate content (450). While the majority of users may comply with common rules of decency within the framework of published material, or may comply with a user agreement defining appropriate messaging, an automated confirmation may be implemented. Accordingly, the platform may implement a speech recognition algorithm that reviews the message prior to publication for unacceptable words or terms. Similarly, all scripts created by product or service providers may be subject to review for conformity with a user agreement. A rejection of the message may prevent the publication of the message, or may automatically delete the message. Alternatively, a rejection may prompt the user to record new audio (at 430).

Once all parts of the first message are uploaded or recorded, an application implementing the platform may combine all components, create the first message, and distribute it (460) in accordance with the method described above with respect to FIG. 3. The first message may then be hosted on a server where it can be distributed via a social media network, or it may be incorporated into a social media platform where that platform can support the message type created. The message may be, for example, a video file or an animation file.

In one embodiment of the present invention an application implementing the platform performs an active role in integrating an uploaded video into the message animation backgrounds. For instance, the app in one embodiment resizes a video in a file received from a user to fit requirements of the message animation backgrounds. For instance, a video format of the received video may be too wide or too long and may need to be edited or cropped. The app may also recognize and convert video formats where appropriate.

After completion of all edits and combination of the message with the background, the message may be played for review and approval of the user prior to distribution.

In one embodiment, the first message is created at a location of business or by a person working as an employee or on behalf of a business or organization. For instance, a restaurant or a theater or a car dealership may request that a patron have his or her video/audio recorded during a visit or presence at their facility. Alternatively, the business may provide a link to a template for creating a first message, or may contact the first user after they have used the service. Similarly, a professional or contractor, such as a plumber, who has just performed a job to the satisfaction of the consumer at a work location, may direct a first user to create such a message. While a consumer may be happy with a meal, a product or a service, he or she may not follow through with the creation of the first message later. In that case it may be beneficial to request the patron or customer directly to answer some survey questions, which may have scripted answers, about the quality of the service and the experience of the first user. The responses to those survey questions may be recorded in an image, video, or audio file to be inserted in a message at a later time. In some embodiments, the business may send a follow up email to the first user after providing such a service, and the user may then record survey responses, or read a script at home. In some embodiments, the fact that the business has reached out to the first user functions as authentication of the first user having access to the service.

In some embodiments, the product or service provider may create the first message themselves and distribute directly to secondary users. In such embodiments, the receipt of such messages from the product or service provider may function as authentication of the secondary user's access to the product or service.

The background associated with a template may include celebrity characters or multiple characters in order to feature more than one person in the message. The completed first message may then be made available for download from a server for the patron/customer.

FIG. 6 illustrates one example of a message animation background 800 for use in the method of FIG. 3. The message animation background 800 reflects a message for a car dealership as an example of the first message. The first message may include a video or photo, along with user audio and music, as described above. The audio, image and music may be imported as a single combined file 804 or the files may be partially combined or may be individually uploaded to be integrated with a message animation background 800. As shown, the message animation background may have a defined area 802 for integrating user content. Alternatively the area 802 may be blended with a background or with images in the message animation backgrounds by using blending or other image processing programs, such as by interpolation and fading or blending at the edges of the video. Accordingly, the first message will provide a total look which hides the fact that the end result is a combination of different files.

The message animation background may include a hyper-link to a business website or a micro-site that includes pertinent business contact information on location, directions, hours of operation and special offers provided through the platform.

As discussed above, a secondary user may evaluate the first message. Accordingly, a link provided with the message background may have a component or location at which a secondary user can evaluate the first message. As discussed above with respect to FIG. 3, such an evaluation may only be allowable when a secondary user has had access to the product or service being reviewed. Alternatively, a review may be given a different amount of weight if a user is confirmed to have had access to the product or service being reviewed. Accordingly, the platform may use location or GPS data to identify when a person who has viewed the message on his or her mobile computing device is with the device in the business location.

In some embodiments, where a secondary user is determined to have had access to the product or service, the user may be sent a notification that they are eligible to make an evaluation of a WOM message on their device upon viewing the first message. Accordingly, an application implementing the platform may play the first message and then request that the consumer, or secondary user, rate the original message maker's, or first user's, recommendation with respect to their own taste as positive, neutral or negative. This rating may act as a secondary message provided by the second user, as discussed above with respect to FIG. 3. Further, the evaluation data may be subsequently used in a valuation method for determining the value of the first message. Accordingly, in an implementation in which the platform may be monetized by the first user, these evaluations may be required for the first user to earn money for their WOM messages distributed through the platform.

In some embodiments, the secondary user may be prompted to create their own more complete message by incorporating images or audio into a template based background, as described above. Alternatively, the secondary user may be asked to pass along the first message, with or without their own recommendation, to their own social contacts. This process allows messages to be tracked so that referral processes can be better understood by product or service providers, and is therefore similar to asking a patron if it is their first time at the establishment, or who recommended that they visit the establishment, as well as whether they enjoyed the experience. An application implementation the platform may therefore organize the individual queries into structured data to build chains of engaged users as a CRM tool. It may also organize communication data to show the path of recommendations and referral of word of mouth by identifying the paths of connections within the social networks, as a result the data collected can identify the attribution value of a message.

Accordingly, the platform described may apply values to individual messages based on the reach of the message, the engagement of users with the first message, and the likelihood of users to agree with or approve of the message. The resulting path of sharing in a social network, for example, builds data related to tastes and preferences related to specific consumers. The data collected is valuable in allowing business organizations to evaluate their advertising and marketing budget.

The platform builds a profile of consumer product preferences, demographics and influence with like-minded groups of consumers, their friends and family for each user of the platform. The platform may further include short surveys on behalf of advertisers, such as the product or service provider, as part of a process to collect additional data on consumers to complete profiles.

The platform therefore generates and distributes authentic, personalized, and organic content in the form of a product or service review. The first message is then shared in social networks for friends to view, reference, and save for later. The message can also be distributed by email or text message, as well as through a social media platform, as discussed above. The receipt of the message containing a positive sentiment from a friend may then increase the consumer engagement rate with online display content advertisement.

In some embodiments, a first user generating and distributing first messages may then earn rewards in the form of money, points, or a combination thereof from the message after some threshold level of evaluation or authentication is achieved. In order to distribute such rewards, a scoring mechanism is applied to the first message that evaluates the message as it flows through the engagement process of viewing, location detection, evaluation (review of the first user's message in relation to a secondary user's taste) and conversion rate. As the message increases in popularity within the platform, consumer engagement with the first message, the influence demonstrated by views, clicks on links and the evaluation location process, the value of the first message will rise.

In one embodiment of the present invention the scoring mechanism is calculated by one of the following two expressions:

a. Score1(a)=create+n1*post+n2*watch

or

b. Score1(b)=create+n1*post+watch.

The scores are then calculated based on the creation and approval of the first message (“create”), the number of social media platforms on which the first message is “posted” (n1) and a number of secondary users who have “watched” the message (n2). Each of the steps of the process may be weighted differently in order to assign a value to each viewer (n2) for example. Accordingly, the platform may determine that merely creating a first message should be assigned no value or only a low value (0-1, for example). Posting to multiple social media platforms, however, may be assigned a higher value (1-10, for example) due to increased exposure of the message. Similarly, watching of the first message may be assigned a higher value.

Other values may also be assigned as well, to steer activities within the platform by using incentives. Accordingly, the following formula may be used:

a. Score2=location*[n3*evaluated+n4*review value+n5*location conversion].

The variables n3, n4 and n5 may therefore indicate numbers of the related activity or score. This version of the scoring formula may be based on GPS location criteria, sometimes referred to herein as a “came and seen” criteria, and may therefore result in a more valuable evaluation where the location of the user is closer to the location of a business offering the service described. The term “evaluated” indicates that the first message has been reviewed by a secondary user and N3 therefore indicates the number of reviews by secondary users. Another score may further indicate that the secondary user has created his or her own first message and distributed it.

The review value may then take into account the score of the review. For example, a positive review, or a “like” may be more valuable.

In some embodiments, the product or service provider, or an advertiser, may purchase the message to be distributed on digital media websites where contacts of the first user within the social network visit that digital media site. For instance, a high valued targeted message may appear for a contact of the first user within a social network instead of a generic display ad.

In some embodiments of the present invention, a score related to a posting of the first message on various websites is tracked. The score is then increased every time the first message is opened or activated on a website or is posted or reposted on a website. A score may also be increased when a particular website on which the message is posted is associated with at least a certain number of contacts (“friends”) that can potentially view the message. A purchase price for such a message when sold to the product or service provider may then be based on a nominal engagement and evaluation score of the message that must be achieved before earning compensation for the message as well as the more comprehensive scoring described above. Compensation may be a credit, cash, discount, product, service, or some combination thereof.

Further, data related to the chain of evaluation is another valued commodity, as it describes word of mouth (WOM) processed through the platform provided herein and therefore becomes a connected database of referral traffic for target marketing. The data can then provide a path to advertise a similar product or service towards groups with substantiated similar interests and tastes. The data therefore allows for a high return on investment in advertising.

An application implementing the platform may create suggestions for consumers based on the data contained therein and issue trending reports of trends in the area of home, work, and other relevant locations linked to GPS coordinates. The application may then provide reports to users and advertisers on the valuation of the word of mouth message. Users will be able to follow their accumulation of points, evaluations and earnings through a user interface of the application.

Further, advertisers can use the platform to recognize users in real time with awards and special offers for their influence and focus advertising dollars on the influential, highly valued network chains. In one embodiment of the platform described, the information collected is transformed consumer data based on relationships of people in close geographical proximity to businesses looking to utilize the platform. The valuation of messages will then consider the information collected from a mobile application interface, and stored in databases with variable importance ratings in order to achieve targeted marketing campaigns.

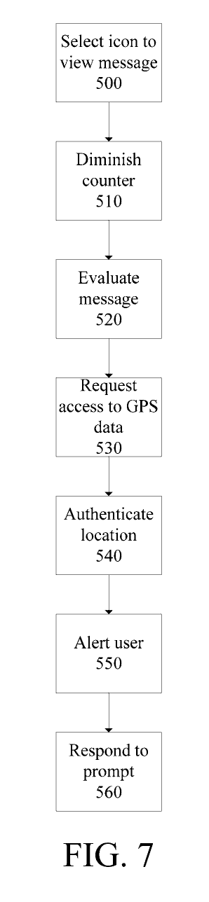

FIG. 7 illustrates methods for implementing a portion of the platform described. In particular, aspects of the evaluation process are illustrated. When a secondary user is using an application implementing the platform described, a message viewing icon may appear (500) within the user interface and a counter may indicate how many unviewed messages remain for viewing by the user. Other counters within the interface may indicate how many times the message has been viewed within the platform, or how many messages are awaiting evaluation by the user utilizing the application.

A first message may have a countdown that diminishes each time the first message is viewed or evaluated. Accordingly, after a first message is viewed a number of counters may be diminished (510). Further, after viewing a first message, an option to evaluate that message (520) may appear. Prior to allowing such an evaluation to take place, or in some embodiments, prior to providing the option to a user, the platform may authenticate the user by, for example, first requesting access to GPS or other location data (530) and then confirming an authentication by synchronizing with a system belonging to the platform of the business owner (540). When the user is in the required evaluation spot, the interface device may alert the user (550) that they are eligible to review a message. For example, the device may ring. The user can then review the first message and provide a response to a prompt for review (560). For example, the secondary user may select from choices, such as (a) do not agree or negative experience, (b) neutral, or there is no or limited value in the message, and (c) agree, a positive experience.

In some embodiments, the authentication may require a second step. For example, the application may require an image of a QR code or a UPC code or an identifying feature of the locale. For instance, a product may need to be scanned to prove that a consumer has actually purchased the product before they are allowed to evaluate a first message.

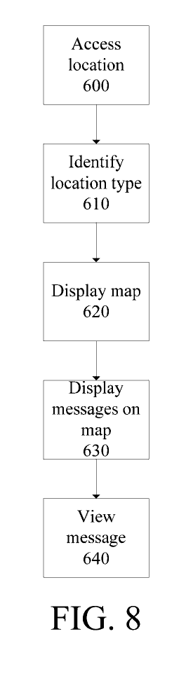

FIG. 8 illustrates additional features that may be implemented in the platform described, including aspects of reporting on evaluated messages. Typically, location access is required (600) to implement features of the application, and nature of the location is identified by a user (610), such as home, work, vacation or enroute to one of those locations. Locations may be displayed on a map on the screen and details of the locations can be entered. Accordingly, a map plotting locations of WOM messages may be queried and displayed (620), illustrating the proximity of business reviewed through the platform to a user's location. Further, a sorted list of WOM messages related to proximity to the locations identified as home or work, as well as the current location, may be displayed (630). Accordingly, a user can view (640) a list of WOM message by selecting a relevant icon in the user interface.

In some embodiments, first messages, or alerts, may appear in real time to a secondary user based on their location. Accordingly, when a secondary user drives by a location with which a first message is associated, the secondary user may be presented with the first message.

In some embodiments, a processor tracks who is viewing the message by leaving a MESSAGE KEY ID with the viewer's device. The processor, as part of the method, is programmed to track the message through the viewer's device. The processor may further track clicks through the message, such as clicks through hyperlinks embedded in message backgrounds and interactions with micro-websites of product or service providers. The processor may further evaluate the ranking of a message by its evaluation by viewers on their devices. The processor may further evaluate the data to determine various social connections, such as the influence of various leaders, followers, and connectors within social networks by ranking resulting activities and by calculating scores based on activities tracked.

For example, a first user messages to 100 friends that he likes pizza at restaurant A, 75 people view it, and 50 go to the restaurant and spend an average of $50 with 45 of those 50 secondary users indicating that they agree with the friends WOM message. 40 of those secondary users may then go ahead and make their own secondary message and send it to 200 friends each. The result is 8000 new messages distributed across a social hierarchy and $2500 of revenue attributed to the first message.

Similarly, a first user may message to 500 friends that he likes pizza at restaurant A, 350 people view it and only 20 show up at the restaurant and spend an average of $75 with 15 secondary users indicating that they agree with the friends WOM message. 10 of those secondary users may then go ahead and make their own secondary messages and send them to 500 friends each. The result is 5000 new messages distributed across the social hierarchy and $1500 of revenue attributed to the first message.

In these examples the first user having the smaller, yet more engaged network attributed to a hirer flow rate of the WOM message and higher revenue spend.

In some embodiments, the application may detect a user's location and provide messages based on that user's proximity to a service provider. Alternatively, the application may record a user's daily, weekly, or monthly routine and provide messages based on routes frequently traveled.

The implementation may generate reports. As such, the server will collect data generated from a plurality of devices that are used to access the platform and view messages and store the data in a database that is searchable on different search terms, including user, data and time, location and keywords extracted from either text or speech recognition. As the database incorporates additional data, the platform may provide suggestions for users to consider. These suggestions may be based, for example, on previously viewed messages and actual locations of users. The platform may also track trending products or services and issue trending reports. Potential advertisers may be provided with reports of activity my users, along with pricing information for the purchase of individual messages for use as advertisements.

Each user of an application implementing the platform may be provided with a user profile associated with them. This may include information inputted at registration, including, for example:
a. Email address—login with password
   i. User ID—Name—First, Middle, Last
   ii. Gender
   iii. Birth year
b. Location data—mark using mobile locator gps
   i. Home
   ii. Work
   iii. Vacation
c. Profile data file—data collected on users to establish demographic profiles
   i. Education
   ii. Profession
   iii. Ethnicity
   iv. Language preference
   v. Profession
   vi. Children
   vii. Marital status
   viii. Info suggested by business platform subscribers

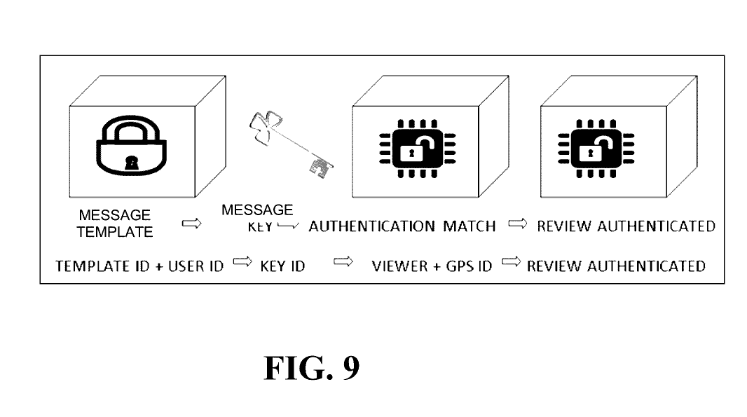

FIG. 9 illustrates an authentication method that may be used in the platform described.

In order to track the authentication and evaluation of individual messages, the message background may be encoded with a unique identification number. The completed personalized message is then issued a key. The key is coded to identify the message maker and has a unique code to unlock a portion of the message animation background for evaluation. A copy of the key is left with everyone who views the message, and the key is activated, allowing for evaluation, when a message keyholder is in the location of the business, or otherwise authenticated. This may then activate the evaluation icon in a user interface of a related application.

FIG. 10 is a schematic diagram illustrating the spread of a message across the platform described.

As shown, a chain may be started by a first user with USER ID #11 by creating a first message #247. A secondary user with USER ID #1 views the first message and is given a key. When the GPS location criteria matches the location criteria set in the background of message #247, user #1 is may be notified that they are eligible to evaluate the message. User #1 then provides a positive (+) review. User's #2 and #4 provided a negative (−) and neutral (0) review, respectively, and users #3 and #5 also provides a positive reviews. As shown, a chain develops well through user #5 as well as through user #9 who views a secondary message distributed by user #5.

The distribution of the message based on this schematic diagram may be used to determine compensation for the various users involved for creating and distributing messages.

The platform described provides an objective and authenticated value to a personal recommendation of a consumer about a product or a service. In some embodiments, implied recommendations, for instance by activating a “like” button, can be made without any proven significant exposure to a service or product and it may not be prudent to rely on a recommendation for a service or a product based on a number of “likes.” Alternatively, some implementations may require that use of a product be authenticated prior to allowing a user to “like” a product or service. It will be understood that a “like” button is described only as an example, and the platform may provide alternative ways to express approval or disapproval.

The platform may also provide several levels of evaluation of a product or a service. Initially, a first message must be created. One can then assess, by viewing such a message, the credibility of the recommendation. A rating of the message can be provided, wherein one type of rating may include the credibility of the message. When someone acts on the recommendation a further recommendation may follow. Such a recommendation is authenticated by proof of exposure to the product/service or presence at a location where the product/service is delivered.

This authenticates the recommendation as being very likely based on a real exposure. This is of course different from a traditional word-of-mouth recommendation.

The terms ‘authenticate’ and ‘authentication’ are used herein. A recommendation, or WOM message, being “authenticated” means that the person who makes the recommendation or WOM message about a service or product was actually exposed to the product or service, has actually purchased the service or products or was at least personally in a place where the product is available or a service was performed.

As an illustrative example a user with an interface device, such as a smartphone having both WiFi and GPS connectivity, visits a Pizza Restaurant.

The Pizza Restaurant may have a WiFi hotspot that allows the smartphone to connect to the Internet. Alternatively, the smartphone may connect to the Internet through the wireless telephone network.

The user of the smartphone may be alerted, via the application, that an app for recommending the Pizza Restaurant experience is available from a website. The website may be an App Store, or a website hosted by a service provider or under the control of the Pizza Restaurant or any other website that can host an app that can be downloaded to the smartphone. The user may then download and install the application. The user may do this prior to a visit to the Pizza Restaurant, or during a visit to the Pizza Restaurant.

A downloaded and installed app in accordance with an aspect of the present invention may be general or may be specific to a particular business location or a particular chain of businesses. Upon loading the application, the application may detect the location of the smartphone and perform actions based on presence at a particular establishment. Accordingly, loading the application may lead to the display of a template that can be used to create a message using the methods described above. In some embodiments, templates may be stored on the smartphone prior to activation of the application or prior to loading the application at the store. If more than one template is available the user selects one template to be used for creating a message related to the Pizza Restaurant.

The location of the smartphone may be checked against the GPS location of the business, which may be a range of GPS coordinates, or a geofence, within which the business is located, which authenticates the user.

An image and audio recording of the user may then be recorded with a camera and microphone in the smartphone and may be integrated into the template. The final message may then be presented to the user for review and approval. In some embodiments, if the message is not approved, it is destroyed.

The first message may then be evaluated on a server for acceptability. Typically, the message is brief. In some embodiments, the messages are shorter than 16 seconds so that they can be used in certain advertising contexts. A server processing the message may be programmed for voice recognition and may then extract words from the sound recording in order to search for negative words such as “bad”, “unacceptable”, “disgusting” and other, potentially inappropriate words. If such words are detected the first message is rejected. Accordingly, the message may be reviewed for quality and content prior to being distributed.

In some embodiments, where the audio is from a script, the evaluation may simply review the message for deviations from the script, in which case, it may not be distributed.

By approving a message for distribution, the first user may authorize the application to distribute the message through various internet platforms, including social media platforms, as well as sharing various data about the user.

A secondary user that is a social media connection of the first user may then view the message on one of the various internet platforms, such as a social media platform, and may download the application themselves. Upon viewing, the user's identity may be recorded at the server and recorded in a record of the chain of distribution of the message. The application may determine if the secondary user is at the location of the Pizza Restaurant based, for example, on GPS information. In some embodiments, the second user may be prompted to review the first message upon detecting that they are at the Pizza Restaurant. For example, the application may provide a coupon for a discount or promotional offering to entice such a viewing.

After viewing the message and authenticating the secondary user's location, the second user may be provided with code or key allowing the secondary user to respond to the first message. The second user may then, for example, “like” the message, and in future viewings of the message by other secondary users, the message may indicate that the “secondary user also liked” the message or some other indication of endorsement of the first message.

The business owner may be able to track how many such first messages are distributed and how many secondary users view and endorse the first messages. In some embodiments, the business owner may purchase the message as an advertisement when certain criteria are met. For example, the threshold criteria may be that the first message was authenticated a number of times within a certain time frame. When the threshold is met or passed, the first message is offered for sale to the business as clearly being of business value to generate new customers. This offer in one embodiment of the present invention is an electronic offer through the platform. The business manager may decide to take a subscription to the message, which can then be used as a normal advertisement that is inserted at strategic locations on the internet.

In one embodiment of the present invention, the secondary user may decide to create a secondary first message. The secondary first message may then include an integrated code or ID that indicates that the secondary first message has as its origin the earlier first message. Thus a chain of first messages can be created and tracked.

In some embodiments, a first user who created a first message is compensated from revenue when the first message is sold as an advertisement. The compensation may, in some embodiments, be contributed to a savings account, i.e. a college fund or retirement account.

The above example illustrates a first message promotion for a place of business. The same approach in an embodiment of the present invention is applied to a product. For instance, the Pizza Restaurant may produce and market Pizza Restaurant Frozen Pizza which can be bought in a store. In such an embodiment, authentication may be by checking GPS data to confirm that a user is at a chain of grocery stores that sells the product being evaluated and/or by having a user scan a UPC code or pizza box evidencing the access to the product.

In some embodiments, because the Frozen Pizza cannot be prepared in the store, a further authentication is required when the smartphone is not in the store. Preferably, the authentication scan or image is made off the premises of the store and may be assumed to be at a place of preparation or use of the product. After that time of scanning, the evaluation interface is activated on the interface device and the first message or corresponding evaluation may be created and submitted.

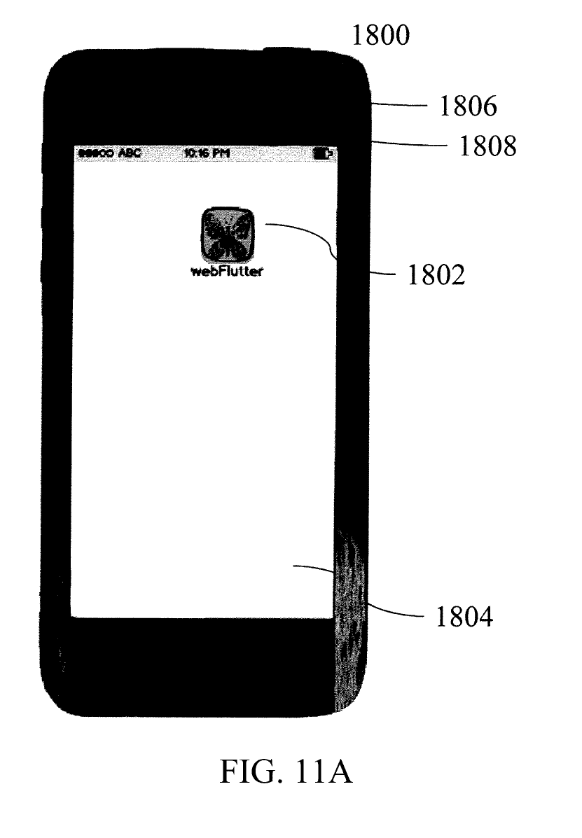

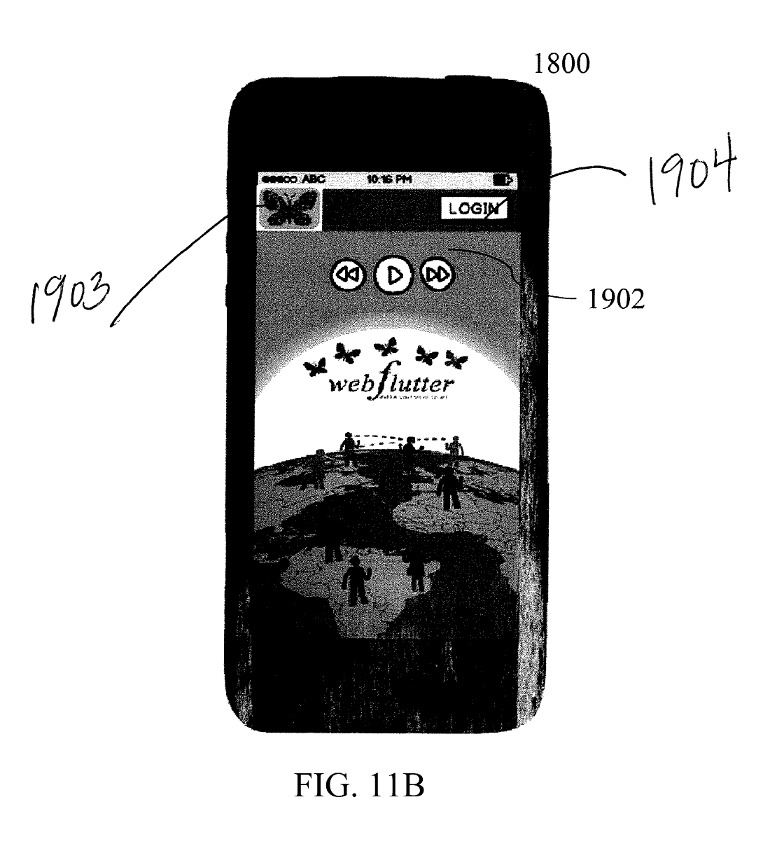

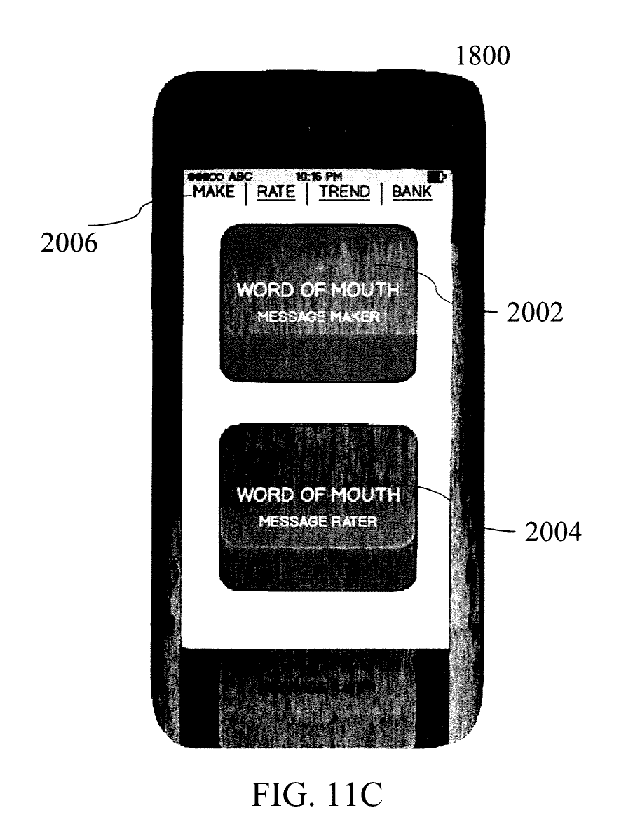

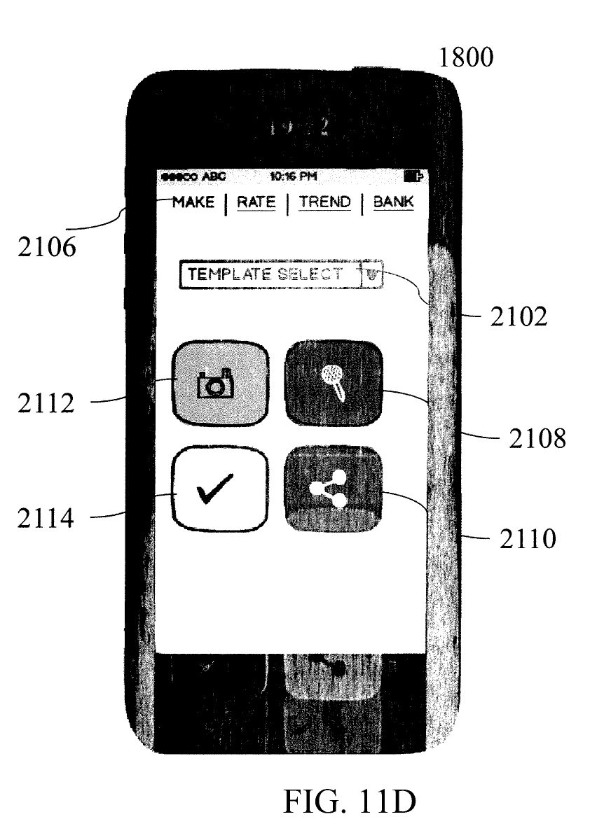

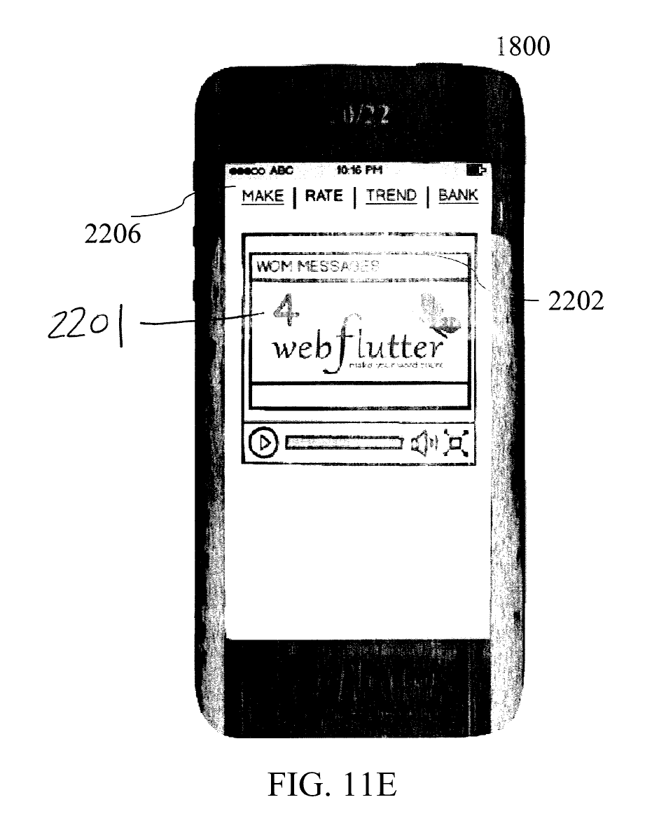

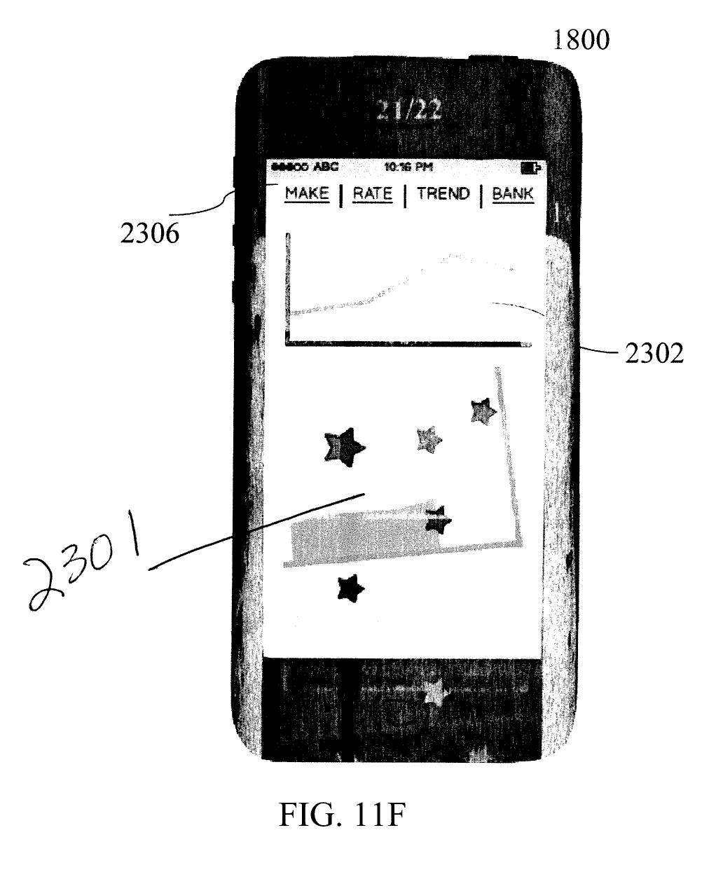

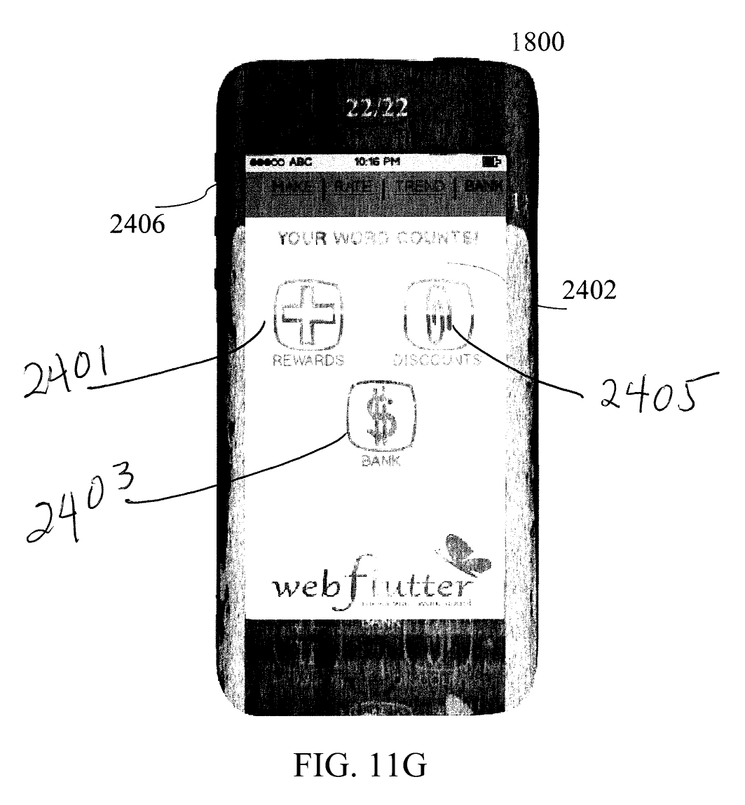

FIGS. 11A-G are exemplary screenshots of an implementation of the platform described. As shown, the app is installed on a smartphone 1800 with a touch screen 1804, a camera 1806 and a microphone 1808. An icon 1802 representing an application implementing the platform is touched to activate the application. The activated app is illustrated in a splash screen app intro video screenshot 1902. The webFlutter icon 1903 provides access to a drop down site navigation menu. The login box 1904 is where users login to the site.

After a logging in, a menu 2006 is displayed a user can choose to create a new message 2002 or rate existing messages 2004. If a user chooses to create a new message by selecting icon 2002 or my selecting “make” from the menu 2106, they may select a prepared message background template 2102. They may then activate recording by the camera 2112 or by the microphone 2108. They may then review and approve the message 2114 and share it over social networks 2110.

Menu 2206 shows the selection of a “rate” page at which users can view webFlutter messages on the WOM message viewer 2202. The display 2201 may indicate a counter counter of messages available to view. Other counters may be integrated to indicate how many viewed messages need to be evaluated and when the authentication criteria is met.

Menu 2306 shows the “trend” page at which users can access various reports of WOM message data based on location criteria, as discussed above. The first trending report of 2302 illustrates reports of trending message suggestions outside ones immediate network but within a geocentric location. The second trending report 2301 illustrates a screen that reports messages on a map of messages within the first user's social network.

Menu 2406 shows the “bank” page at which user's can review rewards for distributing messages through the platform. This provides access to a screen 2402 that enables the app user to identify the rewards of sending messages the people within ones network found to be useful recommendations of products and services. 2401 indicates rewards such as loyalty rewards, wherein a business subscriber can post rewards to the first user for being a valued customer. 2403 indicates the revenue a user earns from their share of the message ad revenue into a deferred savings account. 2405 indicates discounts a business subscriber can post to the first user for being a valued customer or attract new customers based on their social network connections and interests.

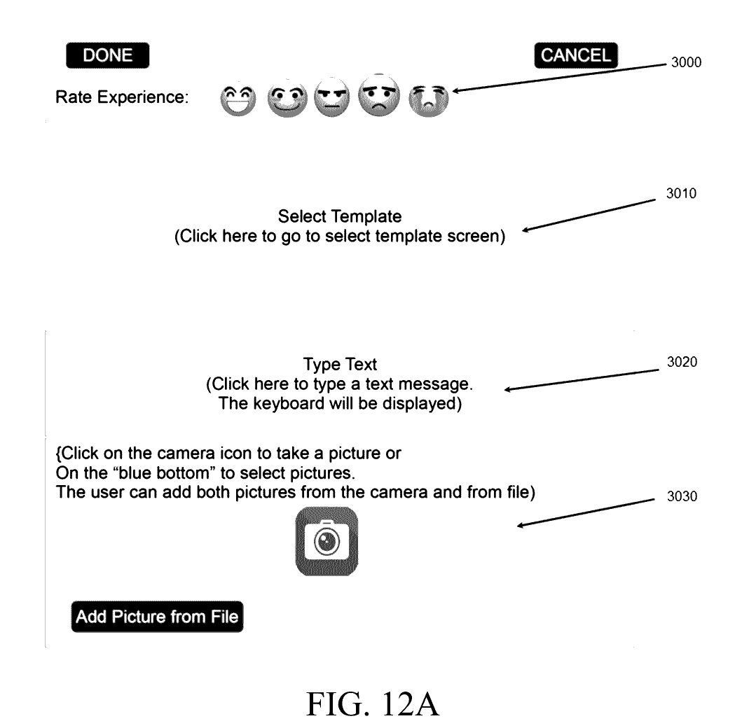

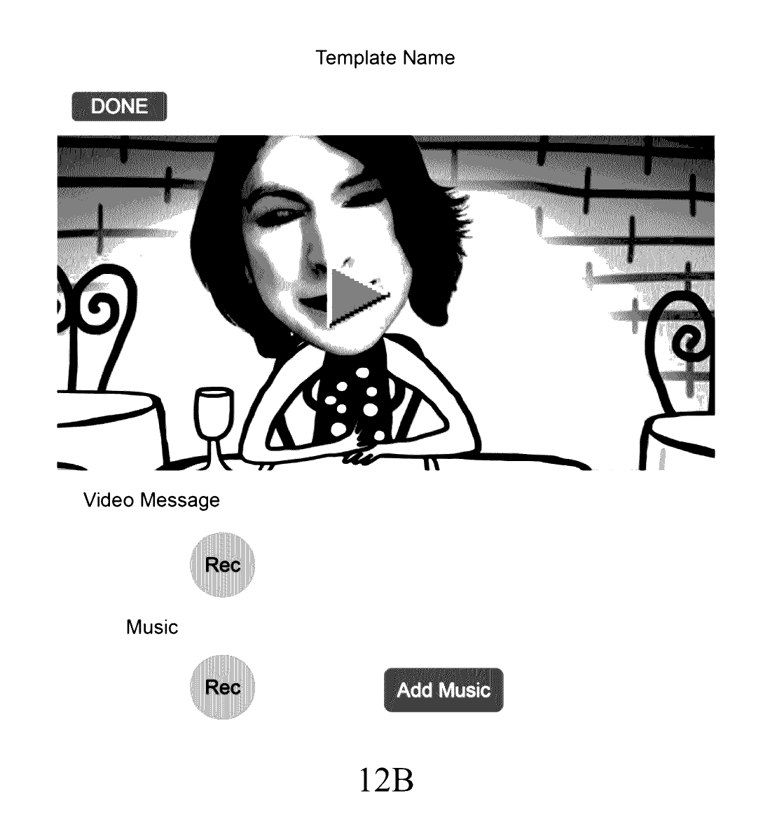

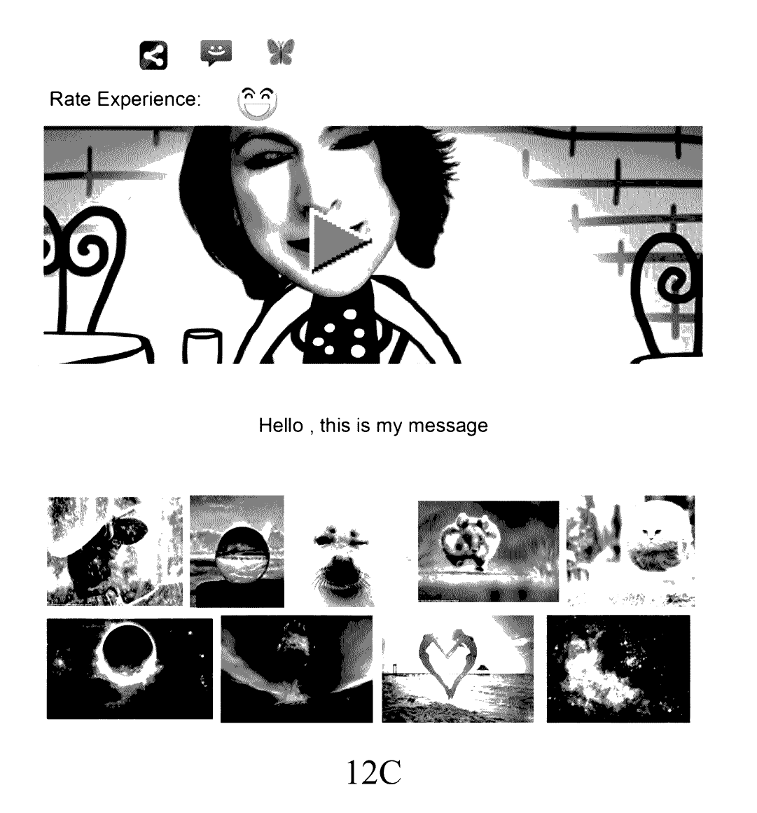

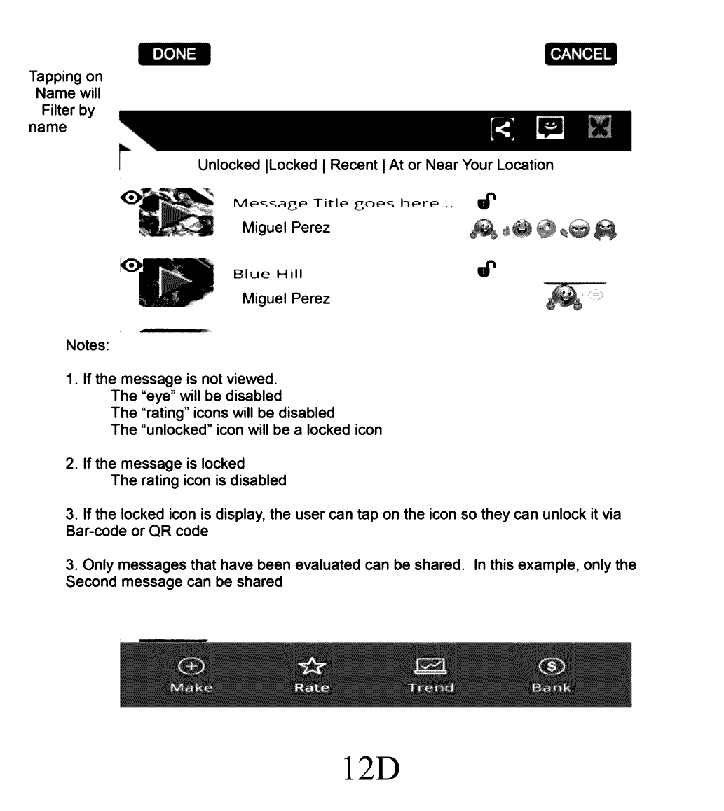

FIGS. 12A-D are exemplary screenshots of a further implementation of the platform described.

FIG. 12A shows the creation of a first message. As shown, a first user may first rate their experience with a product or service by selecting an appropriate emoji, at 3000. Alternatively, a first user may simply rate their experience on a numerical scale, or by merely indicating that they had a positive experience.

A first user may then add a template, at 3010 and incorporate their own text review at 3020. Finally, they may add their own custom content by using a camera to take their picture, at 3030, which would then be integrated into a first message.

FIG. 12B shows a screen where a first user can review a recorded message and record a video or audio message. FIG. 12C shows the same message as it would then be presented to a secondary user.

FIG. 12D shows a list of messages that would be made available to a secondary user. As shown, tapping on a first user's name may filter messages so that only messages from that first user are accessible. A message may then be locked until a secondary user has been authenticated, and is therefore allowed to rate or share the first message or otherwise record a secondary message.

Aspects of the platform described herein relate to computer applications that capture a consumer's personal video or still image and audio message and incorporate it into an animated background that reflects a brand or business's product. The platform may then utilize the message created in this way for the purpose of word of mouth or social media based messaging. The platform may be then be used to monetize the message created on behalf of the consumer by presenting it for sale to the product or service provider, or to other advertisers, or to distribute the message throughout a social network at designated times and places when and where contacts, friends, and family of the consumer that created the message are online. The consumer that created the message may then earn money from the distribution of the message.

An application implementing the platform described, also called an “app,” may be executed using the device described above with respect to FIG. 2, which may be a smartphone, a tablet computer, a laptop computer, or a desktop computer. The device typically includes an integrated camera for recording still and video images and a microphone for recording audio. In some embodiments, the device is connected to an external camera or microphone instead of having such device integrated.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” and like terms encompass all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A computer based method comprising:
Recording, at a first interface device, a first message relating to a product or service;
publishing the first message to a social media platform;
recording, at a second interface device, a second message responsive to the first message;
publishing the second message to the social media platform after authenticating that a secondary user accessing the second interface device has had access to the product or service.

2. The computer based method of claim 1, wherein the publishing of the first message to a social media platform is after authenticating that a first user accessing the first interface device has had access to the product or service

3. The method of claim 1 wherein the second message is an indication of approval or disapproval of the content of the first message.

4. The method of claim 3 further comprising prompting the secondary user to provide a third message relating to the product or service if the second message indicates approval of the content of the first message.

5. The method of claim 1 further comprising:
republishing the first message accompanied by the second message to the social media platform,
wherein the initial publishing of the first message is to a location within the social media platform associated with the first user and wherein the republishing of the first message is to a location within the social media platform associated with the secondary user.

6. The method of claim 1 wherein the first message is in the form of an animation, and wherein a component of the animation is provided to the first user by a provider of the product or service.

7. The method of claim 6 further comprising offering the animation for sale to the provider of the product or service.

8. The method of claim 7 further comprising publishing the animation purchased by the provider of the product or service as an advertisement at locations within the social media platform associated with social connections of the first user.

9. The method of claim 7 wherein the offering of the animation for sale is at a price based in part on the second message from the secondary user and on a quantity of third parties that provide additional messages responsive to the first message.

10. The method of claim 6 wherein the component of the message provided by the provider of the product or service includes contact information or a hyperlink directing viewers to the provider of the product or service.

11. The method of claim 6 wherein the component of the message provided by the provider of the product or service is a background and wherein the first user records a video message to be used as a foreground of the animated message.

12. The method of claim 1, wherein the authenticating that the secondary user has had access to the product or service is by geolocation to confirm that the first interface device or second interface device has been in a location at which the product or service is offered.

13. The method of claim 1, wherein the authenticating that the secondary user has had access to the product or service is by obtaining an image of the product or packaging associated with the product.

14. The method of claim 1 further comprising alerting the secondary user at the second interface device that they are eligible to leave feedback on the first message upon authenticating that the secondary user has had access to the product or service.

15. The method of claim 1 further comprising registering feedback from a plurality of secondary users and assigning a value to the first message based on:
a number of secondary users from whom second messages are published, and
a percentage of the quantity of second messages provided that represent positive responses to the first message.

16. The method of claim 1 further comprising evaluating the first message for its content prior to publishing the message and preventing the first message from publishing if it does not conform to content requirements.

17. The method of claim 1 further comprising transmitting an alert to a provider of the product or service if the secondary message represents a negative response to the first message.
